(19) United States
(12) Patent Application Publication
(10) Pub. No.: US 2003/0191727 A1
(43) Pub. Date: Oct. 9, 2003

(54) Managing multiple data mining scoring results

(75) Inventors: Albert Zhongxing Yao, Austin, TX (US); Prasad Rajendra Vishnubhotla, Round Rock, TX (US)

Correspondence Address: BIGGERS & OHANIAN, PLLC, 5 SCARLET RIDGE, AUSTIN, TX, 78737, US

(73) Assignee: IBM Corporation

(21) Appl. No.: 10/116,648

(22) Filed: Apr. 4, 2002

(51) Int. Cl. G06E 1/00

(52) U.S. Cl. 706/20

(57) ABSTRACT

Managing model scoring results in a data mining environment, the data mining environment having a data mining tool and a data mining model, in which the data mining tool scores scoring input data sets using the data mining model to produce scoring output data and store the scoring output data in records in model scoring results tables. Exemplary embodiments include registering the model scoring results tables in a model scoring results control table, in which the registering includes model scoring results table metadata, selecting from among the model scoring results tables a selected model scoring results table, in which the selecting is carried out in dependence upon metadata from the model scoring results control table, reading a scoring output data record from the selected registered model scoring results table, and storing the scoring output data record in a managed representation table.

### BACKGROUND OF THE INVENTION

1. Field of the Invention

The field of the invention is data processing, or, more specifically, methods, systems, and products for managing multiple data mining scoring results.

2. Description of Related Art

Data mining is a body of analytic techniques to dynamically discover patterns in historical data records and to apply properties associated with these records to production data records that exhibit similar patterns. Based on historical data, a data mining algorithm first generates a data mining model that captures the discovered patterns; this activity is called ‘model training.’ The data mining model so generated is then applied to production data; this activity is called ‘model scoring’ or ‘model apply.’

In this specification, data mining tools are described generally, but we often use the data mining tool known as IBM's Intelligent Miner as a particular example. When we use a data mining tool, such as, for example, IBM's Intelligent Miner, to apply a single mining model, such as, for example, the kind of mining model known as a ‘clustering model,’ to a single data set, the scoring results typically are stored in a single output table that is specifically designed for that mining model and data set. The scoring results so generated typically then are queried by reporting tools to find which record has which score. In practical applications, however, several mining models are created, and each mining model often is used to score several data sets. If the scoring results for every mining model and for every data set on which it can be applied are considered, there often is a large number of scoring result tables that need to be queried by the reporting tools. Because the scoring results are stored in different results tables that have different names, it is very difficult to build queries to select information from the different tables. This presents a situation in which there is no system support to manage the various result tables, although it would be advantageous if there were.

More specifically, it would be advantageous to have a way of using a particular scoring result table to store scoring results from multiple mining models scored on multiple data sets. Such a scoring result table could be queried based on the mining model and data source as well as other keys to extract desired sets of records and their scores. Such a system could provide simplicity, efficiency and ease of maintenance, in addition to a clean interface to scoring results for reporting tools and applications.

### SUMMARY OF THE INVENTION

Exemplary embodiments of the invention typically include methods for managing model scoring results in a data mining environment, the data mining environment having a data mining tool and a data mining model, in which the data mining tool scores scoring input data sets using the data mining model to produce scoring output data and store the scoring output data in records in model scoring results tables. Exemplary embodiments typically include registering the model scoring results tables in a model scoring results control table, in which the registering includes model scoring results table metadata, and selecting, from among the model scoring results tables a selected model scoring results table, in which the selecting is carried out in dependence upon metadata from the model scoring results control table. Some embodiments typically include reading a scoring output data record from the selected registered model scoring results table, and storing the scoring output data record in a managed representation table.

In exemplary embodiments, the model scoring results control table typically includes a name for each data mining model used for scoring, and a name for each input data set used for scoring. In some embodiments, the model scoring results control table typically includes a name for each registered model scoring results table, and a scoring status indicating whether the registered model scoring results control table is actively used.

In exemplary embodiments, the managed representation table typically includes an identification number for each record in each selected registered model scoring results table, a name for each data mining model used for scoring, a name for each scoring input data set, and model scoring results data from each selected registered model scoring results table. In some embodiments, each registered model scoring results table typically includes a record identification number column in which is stored an identification number for each record in the model scoring results table. In other embodiments, the managed representation table typically includes a record identification column in which the identification number for each record from each selected registered model scoring results table is stored, the identification numbers being those identification numbers stored in the model scoring results table record identification column.

In exemplary embodiments, the data mining model is typically a clustering model and the data mining tool typically scores scoring input data sets using the clustering model to produce scoring output data records, to establish clusters, to select from the clusters a best fitting cluster and a second best fitting cluster, to score the fitting quality of each record to the best fitting cluster, to score the fitting quality of each record to the second best fitting cluster, and to establish a confidence value of the cluster assignment of each record. In some embodiments, the managed representation table typically includes a numerical index for the best fitting cluster, a score of the fitting quality of the record to the best fitting cluster, and a numerical index for the second best fitting cluster, for each record. In such embodiments, the managed representation table also includes a score of the fitting quality of the record to the second best filling cluster, and a confidence value of the cluster assignment of the record for each record.

In exemplary embodiments, the model scoring results control table typically includes a registered model scoring results table name column in which a name for each registered model scoring results table is stored, and a data mining model name column in which a name for each data mining model used for scoring is stored.

Exemplary embodiments typically include indexing the registered model scoring results table name column, and indexing the data mining model name column.

In exemplary embodiments of the invention, the managed representation table typically includes a record identification column in which an identification number for each record in the registered model scoring results table is stored, a data mining model name column in which a name for each data mining model used for scoring is stored, and an input data set name column in which a name for each scoring input data set is stored. Some embodiments typically include indexing the record identification column, indexing the data mining model name column, and indexing the input data set name column.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a general process flow diagram illustrating a typical example embodiment of the present invention.

FIG. 2 depicts an example of an embodiment of a metadata table structure for a scoring results control table.

FIG. 3 depicts an example of an embodiment of a metadata table structure for a managed representation table.

FIG. 4 is a process flow diagram illustrating an indexing aspect of a typical example embodiment of the present invention.

FIG. 5 is a process flow diagram illustrating an indexing aspect of a typical example embodiment of the present invention.

FIG. 6 is an example illustration of an embodiment of a model scoring results control table.

FIG. 7 is an example illustration of an embodiment of a managed representation table.

### DETAILED DESCRIPTION OF EXEMPLARY EMBODIMENTS

### Introduction

The present invention is described to a large extent in this specification in terms of methods for managing multiple data mining scoring results. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field” and “data element” are used as synonyms referring to individual elements of digital data. Aggregates of data elements are referred to as “records” or “data structures.” Aggregates of records are referred to as “tables” or “files.” Aggregates of tables are referred to as “databases.” Records and fields in a table in a database are sometimes referred to respectively as “rows” and “columns.”

A “primary key” is a column or group of columns in a table having unique values in each row.

The “Structured Query Language,” or “SQL,” is an industry-standard query language. The industry-standard SQL Data Definition Language (“DDL”) is often used to create data schema or record structures for inclusion in data stores or files. In this specification, scripts operable as DDL scripts for creating record structures in tables are referred to as DDL scripts or as SQL scripts or as SQL DDL scripts.

“IBM DB2 Universal Database,” or “DB2,” is a family of relational database products offered by IBM. “DB2 Call Level Interface,” or “DB2 CLI,” is IBM's callable SQL interface to the DB2 family of database servers, and is an “application programming interface” (“API”) for relational database access. DB2 CLI is based on the Microsoft “Open Database Connectivity” (“ODBC”) specification which is a standard database access method allowing access to data from various applications.

“Java” is an industry-standard programming language. “Java Database Connectivity,” or “JDBC” is an API that allows access from the Java programming language to tabular data sources. JDBC provides cross-database management system connectivity to a wide range of SQL databases and tabular data sources such as spreadsheets and flat files.

### DETAILED DESCRIPTION

In this disclosure, we present exemplary embodiments of a management system for multiple data mining model scoring results. Data mining involves scoring an input data set using a data mining model. The results of a single scoring are stored in a single model scoring results table. A large number of model scoring results tables are created by multiple scorings involving multiple data mining models and multiple input data sets. Each model scoring results table may be individually queried by reporting tools.

The foregoing data mining models, input data sets, and model scoring results tables are data mining objects typically involved in a data mining environment where a data mining tool is used with data mining objects in the performance of data mining activities. For convenience in describing typical embodiments of the present invention, we generally refer to IBM's Intelligent Miner as the data mining tool, although persons skilled in the art will realize that any general-purpose data mining tool providing standard data mining functionality is useful to carry out the pertinent steps for exemplary embodiments of the present invention.

Exemplary embodiments of the present invention, as described in more detail below, typically provide a model scoring results control table in which model scoring results tables are registered. Such a control table in typical embodiments provides metadata useful for selecting model scoring results tables, the selected tables being read such that records from the selected tables are stored in a managed representation table.

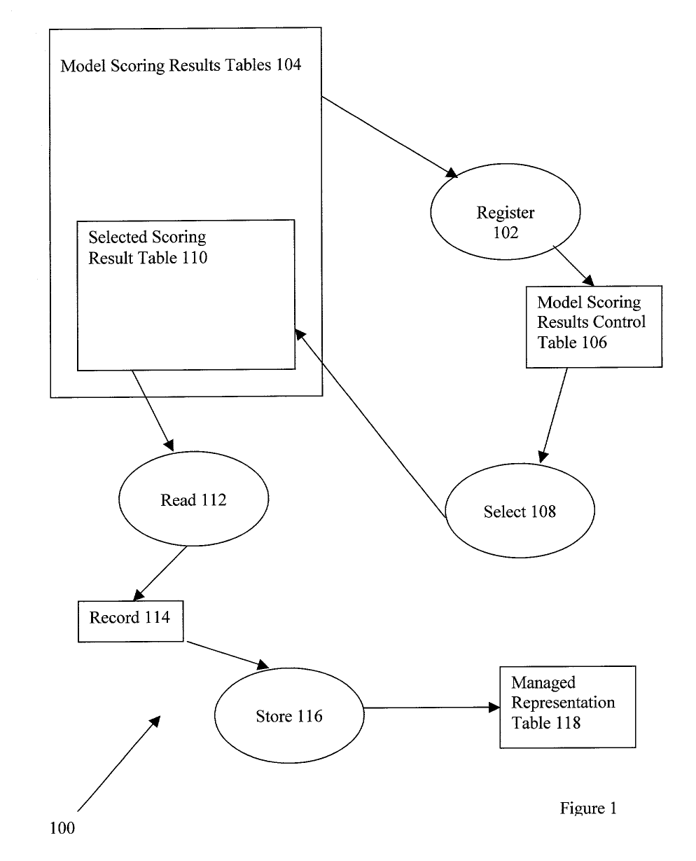

Turning now to FIG. 1, an exemplary embodiment of the present invention is seen to provide a method for managing model scoring results in a data mining environment. The data mining environment has a data mining tool (100) and a data mining model. A typical data mining tool scores scoring input data sets using the data mining model to produce scoring output data and store the scoring output data in records in model scoring results tables (104).

Embodiments of the kind shown in FIG. 1 typically include registering (102) the model scoring results tables (104) in a model scoring results control table (106), wherein the registering includes model scoring results table metadata. Such embodiments also typically include selecting (108), from among the model scoring results tables (104) a selected model scoring results table (104), wherein the selecting is carried out in dependence upon metadata from the model scoring results control table (106). Such embodiments also typically include reading (112) a scoring output data record (114) from the selected registered model scoring results table (110), and storing (116) the scoring output data record (114) in a managed representation table (118).

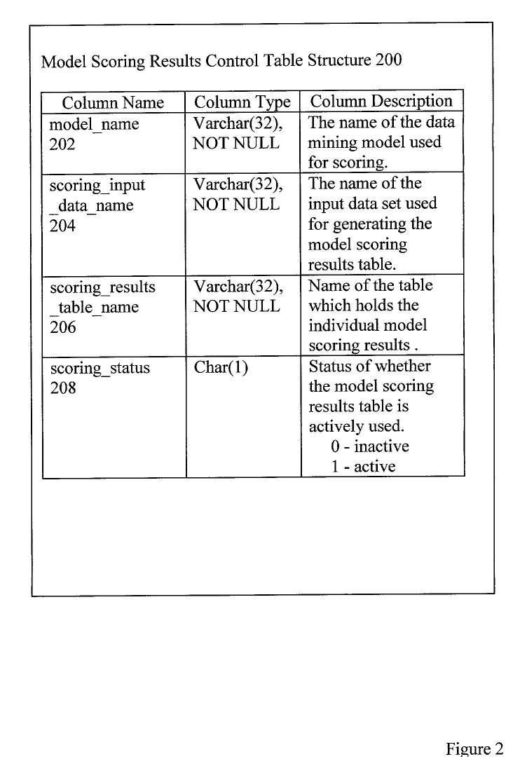

Turning now to FIG. 2, a further embodiment of the present invention is illustrated by use of a data structure (200) for a model scoring results control table comprising a name for each data mining model used for scoring (202), a name for each input data set used for scoring (204), a name for each registered model scoring results table (206), and a scoring status indicating whether the registered model scoring results control table is actively used (208). In some embodiments of the kind illustrated in FIG. 2, the scoring status (208) has the value “0” if the model scoring results table is not actively used and “1” if the model scoring results table is actively used.

The following DDL script is an example of a script useful within various embodiments of the present invention to create a model scoring results control table named “APPTABS” based upon the model scoring results control table (reference 106 on FIG. 1) described above and illustrated in FIG. 2.

create table APPTABS (

| | |
|---|---|
| model_name | varchar(32) not null, |
| scoring_input_data_name | varchar(32) not null, |
| scoring_results_table_name | varchar(32) not null, |
| scoring_status | integer, |

primary key (model_name, scoring_input_data_name)

);

Use of the model scoring results control table (118) provides the benefits of storing the names (206) of all model scoring results tables in a readily accessed single location, along with other information specifically related to each of the individual model scoring results tables, such as the name (202) of the data mining models utilized for the scoring, and the name (204) of the input data used in the scoring. The data mining tool operator is thus provided with a metadata table with a description of all the model scoring results tables, even when the model scoring results tables are generated from multiple applications of different data mining models on different input data sets. Furthermore, the model scoring results control table is readily updatable to include new model scoring results tables. The updating activity is more readily managed and implemented using the model scoring results control table.

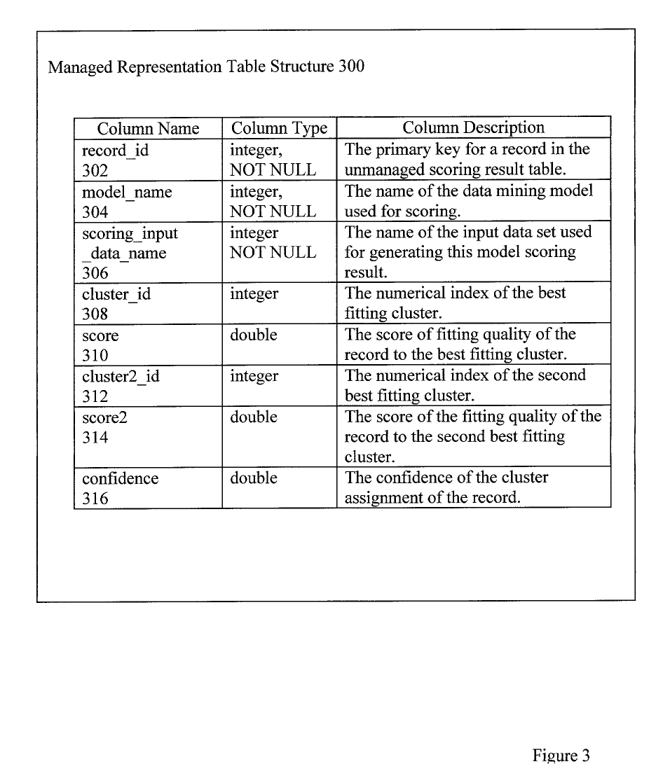

Turning now to FIG. 3, a still further embodiment of the present invention is shown wherein a managed representation table is implemented by data structure (300). The data structure comprises an identification number for each record in each selected registered model scoring results table (302), a name for each data mining model used for scoring (304), a name for each scoring input data set (306), and model scoring results data from each selected registered model scoring results table (308).

In some embodiments of the kind illustrated in FIG. 3, each registered model scoring results table (reference 110 on FIG. 1) further comprises a record identification number column in which is stored an identification number for each record (114) in the model scoring results table, and the managed representation table further comprises a record identification column in which an identification number (302) for each record from each selected registered model scoring results table is stored. The identification numbers stored in the management representation table record identification column are the record identification numbers stored in the model scoring results table record identification column for all the selected model scoring results tables.

In some embodiments of the kind illustrated in FIG. 3, each of the registered model scoring results table has a primary key, the primary key comprising the record identification number column in the registered model scoring results table. A data type of “integer” is shown in FIG. 3 for the record identification column. In situations in which the model scoring results table primary key has a different data type, such as “bigint” or “varchar,” further embodiments of the managed representation table will have corresponding data types for the record identification column. Similarly, if the model scoring results table has a primary key consisting of more than one column, further embodiments of the managed representation table will have additional columns to correspond with the additional primary key columns.

In some embodiments of the kind illustrated in FIG. 3, the data mining model is a clustering model and the data mining tool scores scoring input data sets using the clustering model to produce scoring output data records. When the data mining tool scores the input data sets it establishes clusters and selects from the clusters a best fitting cluster and a second best fitting cluster and scores the fitting quality of each record to the best fitting cluster and the second best fitting cluster. The data mining tool also establishes a confidence value of the cluster assignment of each record. In such embodiments the managed representation table further comprises for each record a numerical index for the best fitting cluster (310), the score of the fitting quality of the record to the best fitting cluster (312), a numerical index for the second best fitting cluster (314), the score of the fitting quality of the record to the second best filling cluster (316), and the confidence of the cluster assignment of the record (318).

The following DDL script is an example of a script useful within exemplary embodiments of the present invention to create a managed representation table named “APPSCORE” based upon the managed representation table (reference 118 on FIG. 1) described above and using the data structure illustrated in FIG. 3.

create table APPSCORE (

| | |
|---|---|
| record_id | integer not null, |
| model_name | varchar(32) not null, |
| scoring_input_data_name | varchar(32) not null, |
| cluster_id | integer, |
| score | double, |
| cluster2_id | integer, |
| score2 | double, |
| confidence | double, |

primary key (record_id, model_name,
scoring_input_data_name)

);

In the foregoing exemplary embodiment, selected model scoring results tables are selected based on metadata in the model scoring results control table named “APPTABS”. The selected model scoring results tables are read and the data obtained by reading such tables is stored in the managed representation table named “APPSCORE”. The following program logic is provided to enable the selecting, reading and storing necessary to populate the managed representation table with the desired model scoring results data.

Select APPTABS.model_name as m_model_name,

APPTABS.scoring_input_data_name
as m_scoring_input_data_name,
APPTABS.scoring_results_table_name
as m_scoring_results_table_name

from APPTABS table where scoring_status=‘1’;

For each m_scoring_results_table_name in the above selected list {

Delete from APPSCORE where

APPSCORE.model_name=‘m_model_name’ and
APPSCORE.scoring_input_data_name=‘m_scoring_input_data
_name’;

Insert into APPSCORE values (record_id,

model_name,
scoring_input_data_name,
cluster_id,
score,
cluster2_id,
score2,
confidence)

Select

key1,
‘m_model_name’,
‘m_scoring_input_data_name’,
Integer(seg_index),
Score,
Integer(seg2_index),
Score2,
confidence

From

m_scoring_results_table_name

} End for

In the foregoing, “key1” is the column name of the primary key in a typical registered model scoring results table. The terms “seg_index” and “score” are the column names in the registered model scoring results table for saving the segment index and its corresponding score for the best fitting cluster. Similarly, the terms “seg2_index” and “score2” are the column names in the registered model scoring results table for saving the segment index and its corresponding score for the second best fitting cluster. The term “confidence” is the column name in the registered model scoring results table for saving the confidence value for cluster assignment.

The foregoing involves the selection from “m_scoring_results_table_name” which is part of the result set of the previous selection from the scoring results control table. This requires dynamic composition of the SQL statement which can be done using JDBC or DB2 CLI.

Use of the managed representation table (reference 118 on FIG. 1) provides the benefits of storing the actual data from multiple registered model scoring results tables in a single table. After selecting the registered model scoring results tables of interest from the model scoring results control table (106), the data mining tool operator is provided with this single managed representation table and can use reporting tools to query the included scoring results with respect to individual records read from the selected model scoring results tables and stored within columns in the managed representation table. In addition to the scoring results data, the managed representation table provides information related to the data. In typical embodiments such related information includes the identification number (reference 302 on FIG. 3) for each model scoring results table record stored in the managed representation table, the name (304) of the data mining model associated with the record, and the name (306) of the scoring input data set associated with the record.

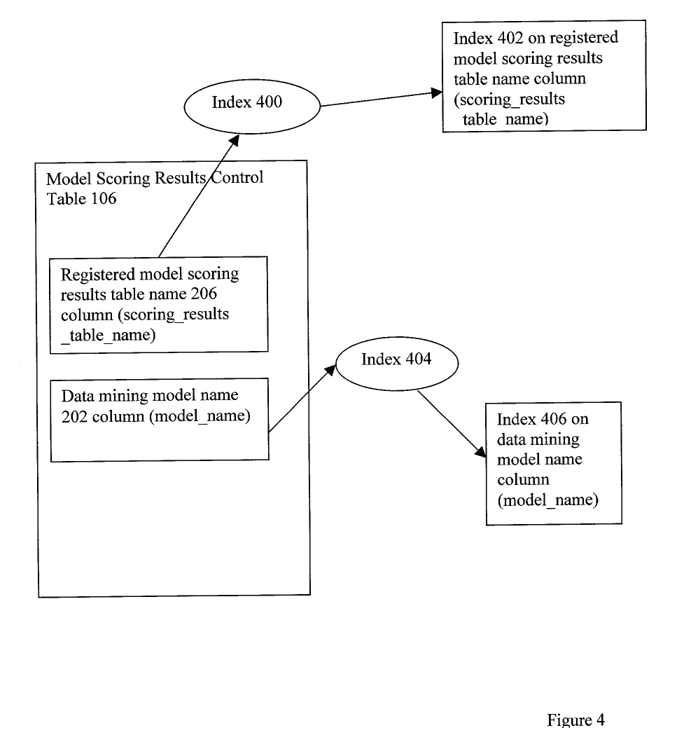

Turning now to FIG. 4, a further embodiment of a model scoring results control table (106) is shown wherein the model scoring results control table comprises a registered model scoring results table name column in which a name for each registered model scoring results table is stored and a data mining model name column in which a name for each data mining model used for scoring is stored. This embodiment further comprises indexing (400) the registered model scoring results table name column to create an index (402) on the registered model scoring results table name column and indexing (404) the data mining model name column to create index (406) on the data mining model name column.

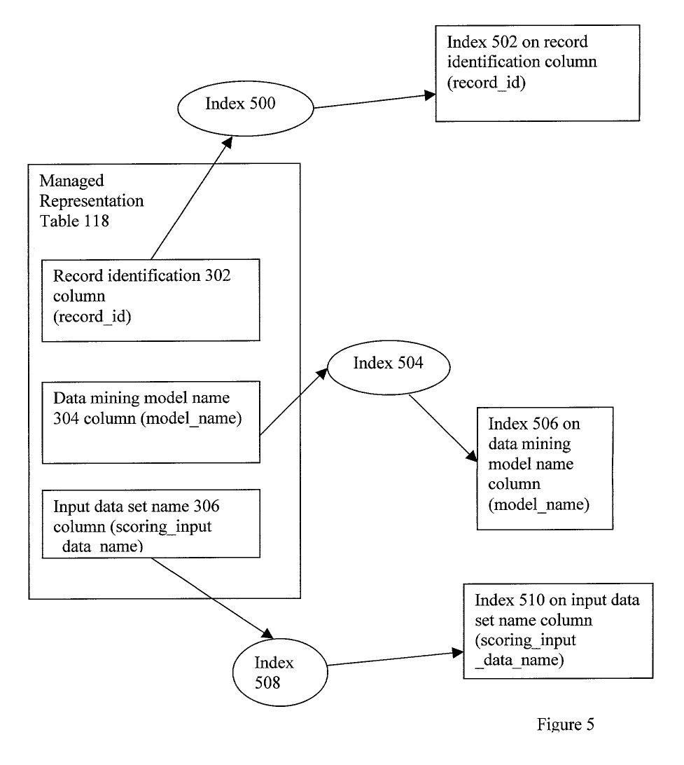

Turning now to FIG. 5, a further embodiment of the managed representation table (118) is shown wherein the managed representation table comprises a record identification column in which an identification number for each record in the registered model scoring results table is stored, a data mining model name column in which a name for each data mining model used for scoring is stored, and an input data set name column in which a name for each scoring input data set is stored. This embodiment further comprises indexing (500) the record identification column to create an index (502) on the record identification column, indexing (504) the data mining model name column to create an index (506) on the data mining model name column, and indexing (508) the scoring input data name column to create an index (510) on the scoring input data name column.

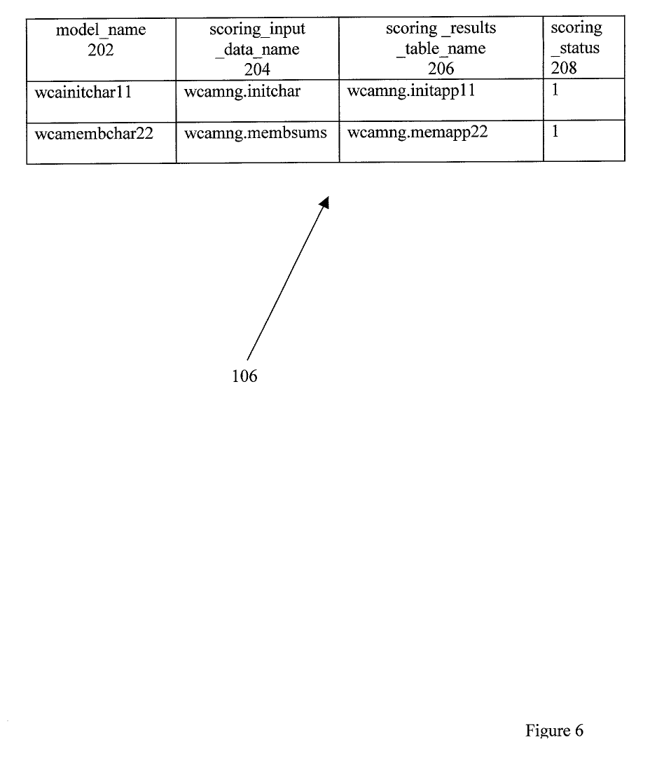

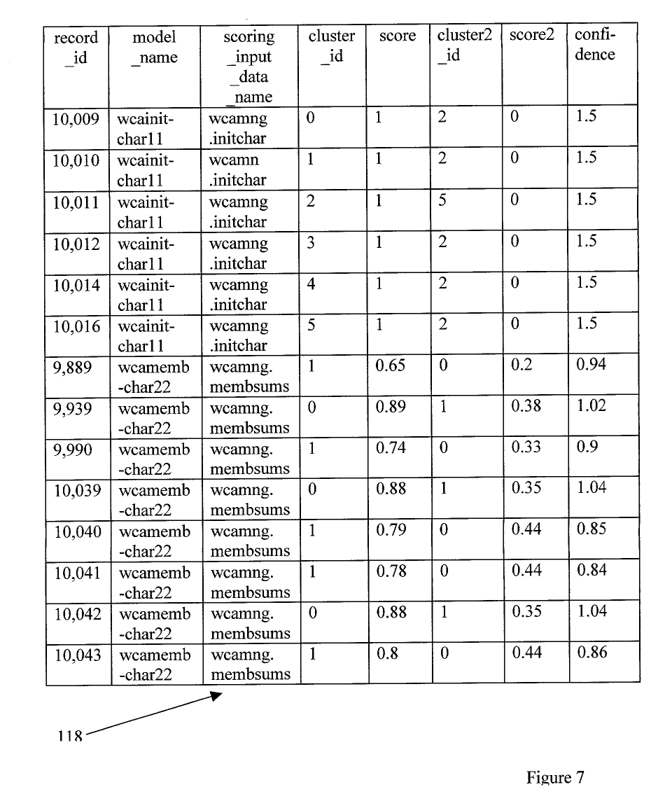

FIG. 6 and FIG. 7 show the details of an exemplary embodiment of the present invention in an example of the multiple model scoring results tables management system wherein the data mining tool utilizes two different data mining models in two different scorings. The example uses the following “Demographic Segmentation Model A” (hereinafter “Model A”) and “Demographic Segmentation Model B” (hereinafter “Model B”).

Demographic Segmentation Model A:

| | |
|---|---|
| Data mining model name: | wcainitchar11 |
| Scoring input data set used as | wcamng.initchar |
| input for model scoring: | |
| Model scoring results table | wcamng.initapp11 |
| for model scoring: | |

Demographic Segmentation Model B:

| | |
|---|---|
| Data mining model name: | wcamembchar22 |
| Scoring input data set used as | wcamng.membsums |
| input for model scoring: | |
| Model scoring results table | wcamng.memapp22 |
| for model scoring: | |

With reference to Model A, and as illustrated in FIG. 6, the data mining model has the name (202) of “wcainitchar11” and the scoring input data set used for the Model A scoring has the name (204) of “wcamng.initchar.” The model scoring results table has the name (206) of “wcamng.initapp11” and is shown to have an “active” scoring status (208).

With reference to Model B, and as further illustrated in FIG. 6, the data mining model has the name (202) of “wcamembchar22” and the scoring input data set used for the Model B scoring has the name (204) of “wcamng.membsums.” The model scoring results table has the name (206) of “wcamng.memapp22” and is shown to have an “active” scoring status (208).

The model scoring results tables “wcamng.initapp11 ” and “wcamng.memapp22” are unmanaged until registered in the models scoring results control table (106) along with related metadata to enable the selection of either or both of the tables for reading. In the example embodiment illustrated in FIG. 7, both model scoring results tables are selected. Records (reference 114 on FIG. 1) are then read (112) from the tables and stored (116) in the managed representation table (118).

The foregoing example illustrates the advantage of managing multiple model scoring results tables in the managed representation table. As shown in FIG. 7, the data mining model name related to each record is displayed in the data mining model name column of the managed representation table along with the name of the related scoring input data set used in the scoring. This information accompanies the actual scores and other scoring output data included in each record. This assembly of information for each record is readily available for querying by typical reporting tools.

For example, in embodiments of this kind, a query that locates records having a “cluster_id” value of “1” locates the record with the “record_id” of “10,010,” as shown in FIG. 7. The managed representation table described in this example embodiment shows that this record was generated when the data mining model “wcainitchar11” was used in scoring the input data named “wcanmg.initchar.” The same query locates the record “9,990,” which was generated when a different data mining model named “wcamembchar22” was used in scoring the different input data named “wcamng.membsums.” Each record located in such a query is accompanied by the names of the related data mining model and the related scoring input data set. This exemplary embodiment illustrates that the use of the managed representation table enhances the querying technique in that a single table can be queried that includes the collected records from multiple model scoring results tables generated by scoring multiple input data sets using multiple data mining models.

It will be understood from the foregoing description that various modifications and changes may be made in the exemplary embodiments of the present invention without departing from its true spirit. It is intended that this description is for purposes of illustration only and should not be construed in a limiting sense. The scope of this invention should be limited only by the language of the following claims.

What is claimed is:

1. A method for managing model scoring results in a data mining environment, the data mining environment having a data mining tool and a data mining model, wherein the data mining tool scores scoring input data sets using the data mining model to produce scoring output data and store the scoring output data in records in model scoring results tables, the method comprising the steps of:
registering the model scoring results tables in a model scoring results control table, wherein the registering includes model scoring results table metadata;
selecting, from among the model scoring results tables a selected model scoring results table, wherein the selecting is carried out in dependence upon metadata from the model scoring results control table;
reading a scoring output data record from the selected registered model scoring results table; and
storing the scoring output data record in a managed representation table.

2. The method of claim 1 wherein the model scoring results control table comprises:
a name for each data mining model used for scoring;
a name for each input data set used for scoring;
a name for each registered model scoring results table; and
a scoring status indicating whether the registered model scoring results control table is actively used.

3. The method of claim 1 wherein the managed representation table comprises:
an identification number for each record in each selected registered model scoring results table;
a name for each data mining model used for scoring;
a name for each scoring input data set; and
model scoring results data from each selected registered model scoring results table.

4. The method of claim 3, wherein:
each registered model scoring results table further comprises a record identification number column in which is stored an identification number for each record in the model scoring results table; and
the managed representation table further comprises a record identification column in which the identification number for each record from each selected registered model scoring results table is stored, the identification numbers being those identification numbers stored in the model scoring results table record identification column.

5. The method of claim 3, wherein the data mining model is a clustering model and the data mining tool scores scoring input data sets using the clustering model to produce scoring output data records, to establish clusters, to select from the clusters a best fitting cluster and a second best fitting cluster, to score the fitting quality of each record to the best fitting cluster, to score the fitting quality of each record to the second best fitting cluster, and to establish a confidence value of the cluster assignment of each record, the managed representation table further comprising for each record:
a numerical index for the best fitting cluster;
a score of the fitting quality of the record to the best fitting cluster;
a numerical index for the second best fitting cluster;
a score of the fitting quality of the record to the second best filling cluster; and
a confidence value of the cluster assignment of the record.

6. The method of claim 1, wherein the model scoring results control table comprises:
a registered model scoring results table name column in which a name for each registered model scoring results table is stored, a data mining model name column in which a name for each data mining model used for scoring is stored,
the method further comprising the steps of:
indexing the registered model scoring results table name column; and
indexing the data mining model name column.

7. The method of claim 1, wherein the managed representation table comprises:
a record identification column in which an identification number for each record in the registered model scoring results table is stored,
a data mining model name column in which a name for each data mining model used for scoring is stored, and
an input data set name column in which a name for each scoring input data set is stored,
the method further comprising the steps of:
indexing the record identification column,
indexing the data mining model name column, and
indexing the input data set name column.

8. A method for managing model scoring results in a data mining environment, the data mining environment having a data mining tool and a data mining model, wherein the data mining tool scores scoring input data sets using the data mining model to produce scoring output data and store the scoring output data in records in model scoring results tables, the method comprising the steps of:
registering the model scoring results tables in a model scoring results control table, wherein the registering includes model scoring results table metadata, the model scoring results control table further comprising a name for each data mining model used for scoring, a name for each input data set used for scoring, a name for each registered model scoring results table, and a scoring status indicating whether the registered model scoring results control table is actively used;
selecting, from among the model scoring results tables a selected model scoring results table, wherein the selecting is carried out in dependence upon metadata from the model scoring results control table;
reading a scoring output data record from the selected registered model scoring results table; and
storing the scoring output data record in a managed representation table, the managed representation table further comprising an identification number for each record in each selected registered model scoring results table, a name for each data mining model used for scoring, and a name for each scoring input data set,
and further wherein each registered model scoring results table further comprises a record identification number column in which is stored an identification number for each record in the model scoring results table, and the managed representation table further comprises a record identification column in which the identification number for each record from each selected registered model scoring results table is stored, the identification numbers being those identification numbers stored in the model scoring results table record identification column,
and further wherein the data mining model is a clustering model and the data mining tool scores scoring input data sets using the clustering model to produce scoring output data records, to establish clusters, to select from the clusters a best fitting cluster and a second best fitting cluster, to score the fitting quality of each record to the best fitting cluster, to score the fitting quality of each record to the second best fitting cluster, and to establish a confidence value of the cluster assignment of each record, the managed representation table further comprising for each record a numerical index for the best fitting cluster, a score of the fitting quality of the record to the best fitting cluster, a numerical index for the second best fitting cluster, a score of the fitting quality of the record to the second best filling cluster, and a confidence value of the cluster assignment of the record.

9. A system for managing model scoring results in a data mining environment, the data mining environment having a data mining tool and a data mining model, wherein the data mining tool scores scoring input data sets using the data mining model to produce scoring output data and store the scoring output data in records in model scoring results tables, the system comprising:
means for registering the model scoring results tables in a model scoring results control table, wherein the registering includes model scoring results table metadata;
means for selecting, from among the model scoring results tables a selected model scoring results table, wherein the selecting is carried out in dependence upon metadata from the model scoring results control table;
means for reading a scoring output data record from the selected registered model scoring results table; and
means for storing the scoring output data record in a managed representation table.

10. The system of claim 9 wherein the model scoring results control table comprises:
a name for each data mining model used for scoring;
a name for each input data set used for scoring;
a name for each registered model scoring results table; and
a scoring status indicating whether the registered model scoring results control table is actively used.

11. The system of claim 9 wherein the managed representation table comprises:
an identification number for each record in each selected registered model scoring results table;
a name for each data mining model used for scoring;
a name for each scoring input data set; and
model scoring results data from each selected registered model scoring results table.

12. The system of claim 11, wherein:
each registered model scoring results table further comprises a record identification number column in which is stored an identification number for each record in the model scoring results table; and
the managed representation table further comprises a record identification column in which the identification number for each record from each selected registered model scoring results table is stored, the identification numbers being those identification numbers stored in the model scoring results table record identification column.

13. The system of claim 11, wherein the data mining model is a clustering model and the data mining tool scores scoring input data sets using the clustering model to produce scoring output data records, to establish clusters, to select from the clusters a best fitting cluster and a second best fitting cluster, to score the fitting quality of each record to the best fitting cluster, to score the fitting quality of each record to the second best fitting cluster, and to establish a confidence value of the cluster assignment of each record, the managed representation table further comprising for each record:
a numerical index for the best fitting cluster;
a score of the fitting quality of the record to the best fitting cluster;
a numerical index for the second best fitting cluster;
a score of the fitting quality of the record to the second best filling cluster; and
a confidence value of the cluster assignment of the record.

14. The system of claim 9, wherein the model scoring results control table comprises:
a registered model scoring results table name column in which a name for each registered model scoring results table is stored,
a data mining model name column in which a name for each data mining model used for scoring is stored,
the system further comprising:
means for indexing the registered model scoring results table name column; and
means for indexing the data mining model name column.

15. The system of claim 9, wherein the managed representation table comprises:
a record identification column in which an identification number for each record in the registered model scoring results table is stored,
a data mining model name column in which a name for each data mining model used for scoring is stored, and
an input data set name column in which a name for each scoring input data set is stored,
the system further comprising:
means for indexing the record identification column,
means for indexing the data mining model name column, and
means for indexing the input data set name column.

16. A computer program product for managing model scoring results in a data mining environment, the data mining environment having a data mining tool and a data mining model, wherein the data mining tool scores scoring input data sets using the data mining model to produce scoring output data and store the scoring output data in records in model scoring results tables, the computer program product comprising:
a recording medium;
means, recorded on the recording medium, for registering the model scoring results tables in a model scoring results control table, wherein the registering includes model scoring results table metadata;
means, recorded on the recording medium, for selecting, from among the model scoring results tables a selected model scoring results table, wherein the selecting is carried out in dependence upon metadata from the model scoring results control table;
means, recorded on the recording medium, for reading a scoring output data record from the selected registered model scoring results table; and
means, recorded on the recording medium, for storing the scoring output data record in a managed representation table.

17. The computer program product of claim 16 wherein the model scoring results control table comprises:
a name for each data mining model used for scoring;
a name for each input data set used for scoring;
a name for each registered model scoring results table; and
a scoring status indicating whether the registered model scoring results control table is actively used.

18. The computer program product of claim 16 wherein the managed representation table comprises:
an identification number for each record in each selected registered model scoring results table;
a name for each data mining model used for scoring;
a name for each scoring input data set; and
model scoring results data from each selected registered model scoring results table.

19. The computer program product of claim 19, wherein:
each registered model scoring results table further comprises a record identification number column in which is stored an identification number for each record in the model scoring results table; and
the managed representation table further comprises a record identification column in which the identification number for each record from each selected registered model scoring results table is stored, the identification numbers being those identification numbers stored in the model scoring results table record identification column.

20. The computer program product of claim 19, wherein the data mining model is a clustering model and the data mining tool scores scoring input data sets using the clustering model to produce scoring output data records, to establish clusters, to select from the clusters a best fitting cluster and a second best fitting cluster, to score the fitting quality of each record to the best fitting cluster, to score the fitting quality of each record to the second best fitting cluster, and to establish a confidence value of the cluster assignment of each record, the managed representation table further comprising for each record:
a numerical index for the best fitting cluster;
a score of the fitting quality of the record to the best fitting cluster;
a numerical index for the second best fitting cluster;
a score of the fitting quality of the record to the second best filling cluster; and
a confidence value of the cluster assignment of the record.

21. The computer program product of claim 16, wherein the model scoring results control table comprises:
a registered model scoring results table name column in which a name for each registered model scoring results table is stored,
a data mining model name column in which a name for each data mining model used for scoring is stored,
the computer program product further comprising:
means, recorded on the recording medium, for indexing the registered model scoring results table name column; and
means, recorded on the recording medium, for indexing the data mining model name column.

22. The computer program product of claim 16, wherein the managed representation table comprises:
a record identification column in which an identification number for each record in the registered model scoring results table is stored,
a data mining model name column in which a name for each data mining model used for scoring is stored, and
an input data set name column in which a name for each scoring input data set is stored,
the computer program product further comprising:
means, recorded on the recording medium, for indexing the record identification column,
means, recorded on the recording medium, for indexing the data mining model name column, and
means, recorded on the recording medium, for indexing the input data set name column.
